(19) United States
(12) Patent Application Publication
(10) Pub. No.: US 2026/0017582 A1
(43) Pub. Date: Jan. 15, 2026

(54) BUSINESS PLANNING RECOMMENDATION GENERATION SYSTEMS AND METHODS BASED ON LOCATION AND SOURCING ALLOCATIONS

(71) Applicant: Allstate India Private Limited, Bangalore (IN)

(72) Inventors: Kamalnath K V, Kerala (IN); Linoy Joy, Kerala (IN); Sarish Paul, Bangalore (IN); Chetan Garga, Bengaluru (IN)

(73) Assignee: Allstate India Private Limited, Bangalore (IN)

(21) Appl. No.: 18/768,691

(22) Filed: Jul. 10, 2024

(51) Int. Cl. G06Q 10/0631

(52) U.S. Cl. CPC G06Q 10/06313

(57) ABSTRACT

Systems and methods for generating a business planning recommendation for a project may include generating weighted location metrics based on location metrics, generating a location allocation decision based on the weighted location metrics, wherein the location allocation decision includes an allocation of a percentage of the project to house at each location of at least two locations of an enterprise, generating weighted sourcing metrics based on sourcing input parameters, generating a sourcing allocation decision based on the weighted sourcing metrics, wherein the sourcing allocation decision includes an allocation of a percentage of the project to source internally within the enterprise and externally outside the enterprise, and generating a business plan recommendation including a location and sourcing allocation decision for each location based on a combination of the location allocation decision and the sourcing allocation decision.

### TECHNICAL FIELD

The present disclosure relates to business planning recommendation generation systems and, in particular, systems and methods for generating business planning recommendation generation for a project based on a location and sourcing allocation decision for the project determining percentages to house between at least two locations of an enterprise with percentages to source internally within and externally outside the enterprise.

### BACKGROUND

Within an organization, when multiple locations collaborate on a project, factors such as location-specific expenses, local vendor accessibility, individual location cost dynamics, and the potential for operational disturbances may be considered to address project allocation concerns. A need exists for business planning recommendation systems and methods that enhance and streamline resource allocation, leading to improved resource utilization and cost control across the diverse locations of the enterprise.

### BRIEF SUMMARY

According to the subject matter of the present disclosure, a system for generating a business planning recommendation for a project may include a processor, a memory, a location analysis module, a sourcing analysis module, a business recommendation module, and one or more machine-readable instructions stored in the memory. The memory, the location analysis module, the sourcing analysis module, and the business recommendation module may be communicatively coupled to the processor. The one or more machine-readable instructions stored in the memory may cause the system to perform at least the following when executed by the processor: generating, by the location analysis module, weighted location metrics based on location metrics received at the location analysis module; generating, by the location analysis module, a location allocation decision based on the weighted location metrics, the location allocation decision comprising an allocation of a percentage of the project to house at each location of at least two locations of an enterprise; generating, by the sourcing analysis module, weighted sourcing metrics based on sourcing input parameters received at the sourcing analysis module; generating, by the sourcing analysis module, a sourcing allocation decision based on the weighted sourcing metrics, the sourcing allocation decision comprising an allocation of a percentage of the project to source internally within the enterprise and externally outside the enterprise; generating, by the business recommendation module, a business plan recommendation comprising a location and sourcing allocation decision for each location based on a combination of the location allocation decision and the sourcing allocation decision.

According to another embodiment of the present disclosure, a system for generating a business planning recommendation for a project may include a processor, a memory, a location analysis module, a sourcing analysis module, a business recommendation module, and one or more machine-readable instructions stored in the memory. The memory, the location analysis module, the sourcing analysis module, and the business recommendation module may be communicatively coupled to the processor. The one or more machine-readable instructions stored in the memory may cause the system to perform at least the following when executed by the processor: generating, by the location analysis module, weighted location metrics based on location metrics received at the location analysis module, wherein the location metrics comprises one or more location parameters comprising respective weighted location parameter metrics; generating, by the location analysis module, a location allocation decision based on the weighted location metrics, the location allocation decision comprising an allocation of a percentage of the project to house at each location of at least two locations of an enterprise; generating, by the sourcing analysis module, weighted sourcing metrics based on sourcing input parameters received at the sourcing analysis module, wherein the sourcing metrics comprise one or more sourcing parameters comprising respective weighted sourcing parameter metrics; generating, by the sourcing analysis module, a sourcing allocation decision based on the weighted sourcing metrics, the sourcing allocation decision comprising an allocation of a percentage of the project to source internally within the enterprise and externally outside the enterprise; generating, by the business recommendation module, a business plan recommendation comprising a location and sourcing allocation decision for each location based on a combination of the location allocation decision and the sourcing allocation decision.

According to yet another embodiment of the present disclosure, a method for generating a business planning recommendation for a project may include: generating, by a location analysis module, weighted location metrics based on location metrics received at the location analysis module; generating, by the location analysis module, a location allocation decision based on the weighted location metrics, the location allocation decision comprising an allocation of a percentage of the project to house at each location of at least two locations of an enterprise; generating, by a sourcing analysis module, weighted sourcing metrics based on sourcing input parameters received at the sourcing analysis module; generating, by the sourcing analysis module, a sourcing allocation decision based on the weighted sourcing metrics, the sourcing allocation decision comprising an allocation of a percentage of the project to source internally within the enterprise and externally outside the enterprise; generating, by a business recommendation module, a business plan recommendation comprising a location and sourcing allocation decision for each location based on a combination of the location allocation decision and the sourcing allocation decision.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a computer-implemented system for business planning recommendation generation including a location analysis module, sourcing analysis module, and business recommendation module and for use with the process flow of FIG. 2, according to one or more embodiments shown and described herein;

FIG. 2 illustrates a flowchart process for the system of FIG. 1, according to one or more embodiments shown and described herein;

FIG. 3 illustrates a display screen of a location analysis user interface of the system of FIG. 1, according to one or more embodiments shown and described herein;

FIG. 4A illustrates a first portion of a weighted location parameter metrics chart of the location analysis module of the of FIG. 1, according to one or more embodiments shown and described herein;

FIG. 4B illustrates a second portion of the weighted location parameter metrics chart of FIG. 4A;

FIG. 4C illustrates a third portion of the weighted location parameter metrics chart of FIG. 4A;

FIG. 5 illustrates a display screen of a sourcing analysis user interface of the sourcing analysis module of the system of FIG. 1, according to one or more embodiments shown and described herein;

FIG. 6 illustrates a scroll bar of a graphic user interface (GUI) system of FIG. 1, according to one or more embodiments shown and described herein;

FIG. 7 illustrates a display screen of a recommendation module user interface of the business recommendation module of the system of FIG. 1, according to one or more embodiments shown and described herein; and

FIG. 8 illustrates a display screen of an organizational structure user interface of the enterprise of the system of FIG. 1, according to one or more embodiments shown and described herein.

### DETAILED DESCRIPTION

In embodiments herein, systems and methods are described for generating a business planning recommendation for a project in an enterprise including at least two locations. The enterprise at each location may utilize personnel to staff the project as external and internal sources. One or more vendors may provide personnel as external sources outside the enterprise at at least one of the locations. The system includes a location analysis module, a sourcing analysis module, and a business recommendation module that are communicatively coupled to generate an optimized business planning recommendation for the project between the at least two locations per a source allocation (e.g., staffing) recommendation based on metrics and factors as described here. As will be described in greater detail below, the location analysis module generates weighed location metrics based on location metrics and further generates a location allocation decision based on the weighted location metrics. The source analysis module generates a sourcing allocation based on sourcing input parameters and further generates a sourcing allocation decision based on the weighted sourcing metrics. The recommendation module generates the business plan recommendation for each location based on a combination of the location allocation decision and the sourcing allocation decision.

Thus, the system integrates both location analysis and sourcing analysis modules, allowing for a comprehensive examination of factors affecting business planning via the business recommendation module. The location analysis module generates weighed location metrics that take into account, as described in greater detail further below, various location-related factors. The location analysis aids the enterprise in determining where to allocate internal resources, weighing the internal resources at each location for the project. The sourcing analysis module considers sourcing input parameters to determine how resources may be allocated between internal personnel of the enterprise and external personnel of external vendors at each location. The sourcing analysis improves the cost allocation between the enterprise and the vendors considering both the short-term and long-term factors, leading to cost savings and efficiency improvements. The use of metrics, weighting, and analysis in both location and sourcing modules emphasizes a data-driven approach to decision-making. The recommendation module combines the outcomes of both location and sourcing allocation decisions to generate tailored business plan recommendations for each location. The generated business planning recommendation ensures that the unique characteristics and requirements of each location are considered, resulting in the planned project suited to the specific requirements and goals of each location and the enterprise as a whole. By considering both location and sourcing factors in an overall combined analysis, the system improves operational efficiency and cost savings for the enterprise.

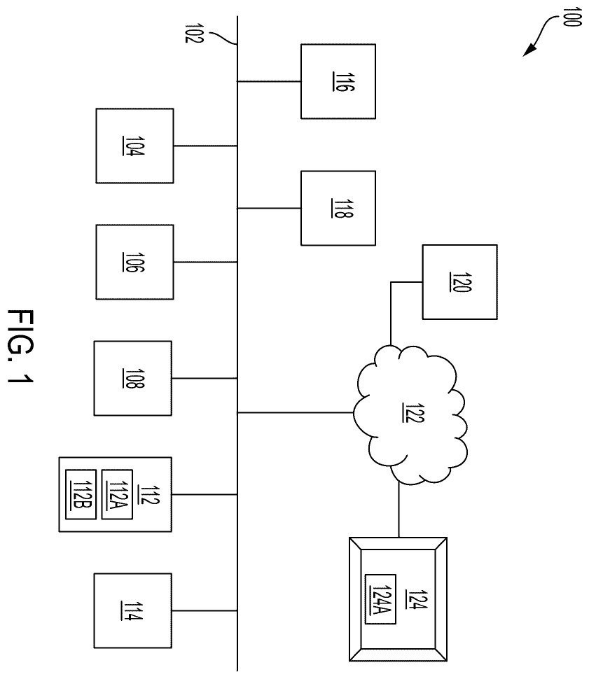

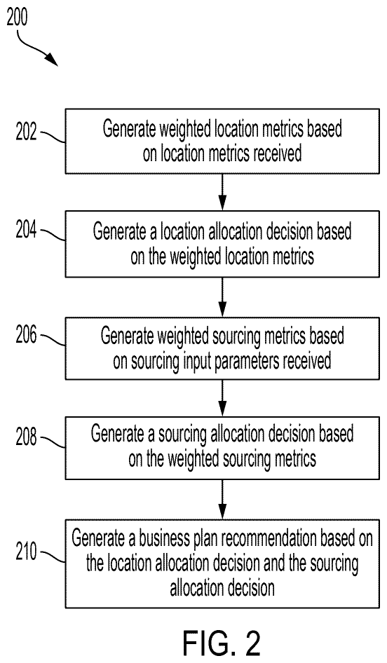

FIG. 1 illustrates a system 100 for generating a business planning recommendation for a project for use with a process 200 of FIG. 2. Referring to FIG. 1, a non-transitory system 100 for implementing a computer and software-based method, such as directed by a location analysis module 112A, a sourcing analysis module 112B, a business recommendation module 112 is depicted to implement the process 200 as described herein. The system 100 comprises a communication path 102, one or more processors 104, a non-transitory memory component 106, input/output devices 108, the location analysis module 112A, the sourcing analysis module 112B, and the business recommendation module 112, a storage or database 114, an artificial intelligence module 116, a network interface hardware 118, a server 120, a network 122, a computing device 124, and a graphical user interface (GUI) 124A. The various components of the system 100 and the interaction thereof will be described in detail below.

While only one server 120 and one computing device 124 are illustrated, the system 100 can comprise multiple servers containing one or more applications and computing devices. In some embodiments, the system 100 is implemented using a wide area network (WAN) or network 122, such as an intranet or the internet. The computing device 124 may include digital systems and other devices permitting connection to and navigation of the network. It is contemplated and within the scope of this disclosure that the computing device 124 may be a personal computer, a laptop device, a smart mobile device such as a smart phone or smart pad, or the like. Other system 100 variations allowing for communication between various geographically diverse components are possible. The lines depicted in FIG. 1 indicate communication rather than physical connections between the various components.

The system 100 comprises the communication path 102. The communication path 102 may be formed from any medium that is capable of transmitting a signal such as, for example, conductive wires, conductive traces, optical waveguides, or the like, or from a combination of mediums capable of transmitting signals. The communication path 102 communicatively couples the various components of the system 100. As used herein, the term “communicatively coupled” means that coupled components are capable of exchanging data signals with one another such as, for example, electrical signals via conductive medium, electromagnetic signals via air, optical signals via optical waveguides, and the like.

The system 100 of FIG. 1 also comprises the processor 104. The processor 104 can be any device capable of executing machine readable instructions. Accordingly, the processor 104 may be a controller, an integrated circuit, a microchip, a computer, or any other computing device. The processor 104 is communicatively coupled to the other components of the system 100 by the communication path 102. Accordingly, the communication path 102 may communicatively couple any number of processors with one another, and allow the modules coupled to the communication path 102 to operate in a distributed computing environment. Specifically, each of the modules can operate as a node that may send and/or receive data.

The illustrated system 100 further comprises the memory component 106 which is coupled to the communication path 102 and communicatively coupled to the processor 104. The memory component 106 may be a non-transitory computer readable medium or non-transitory computer readable memory and may be configured as a nonvolatile computer readable medium. The memory component 106 may comprise RAM, ROM, flash memories, hard drives, or any device capable of storing machine readable instructions such that the machine readable instructions can be accessed and executed by the processor 104. The machine readable instructions may comprise logic or algorithm(s) written in any programming language such as, for example, machine language that may be directly executed by the processor 104, or assembly language, object-oriented programming (OOP), scripting languages, microcode, etc., that may be compiled or assembled into machine readable instructions and stored on the memory component 106. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

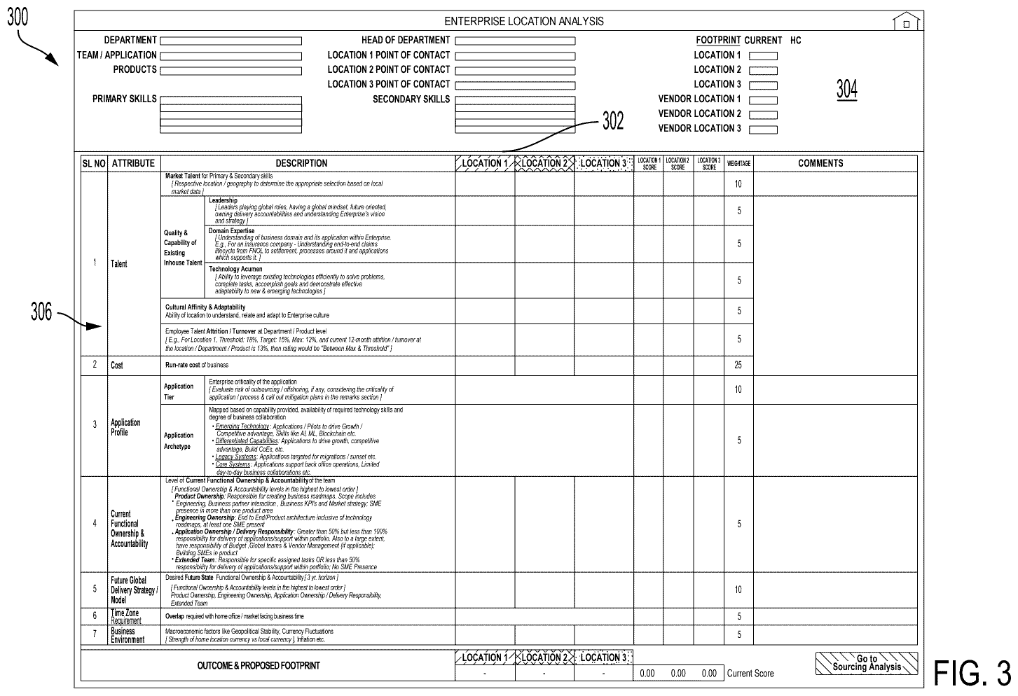

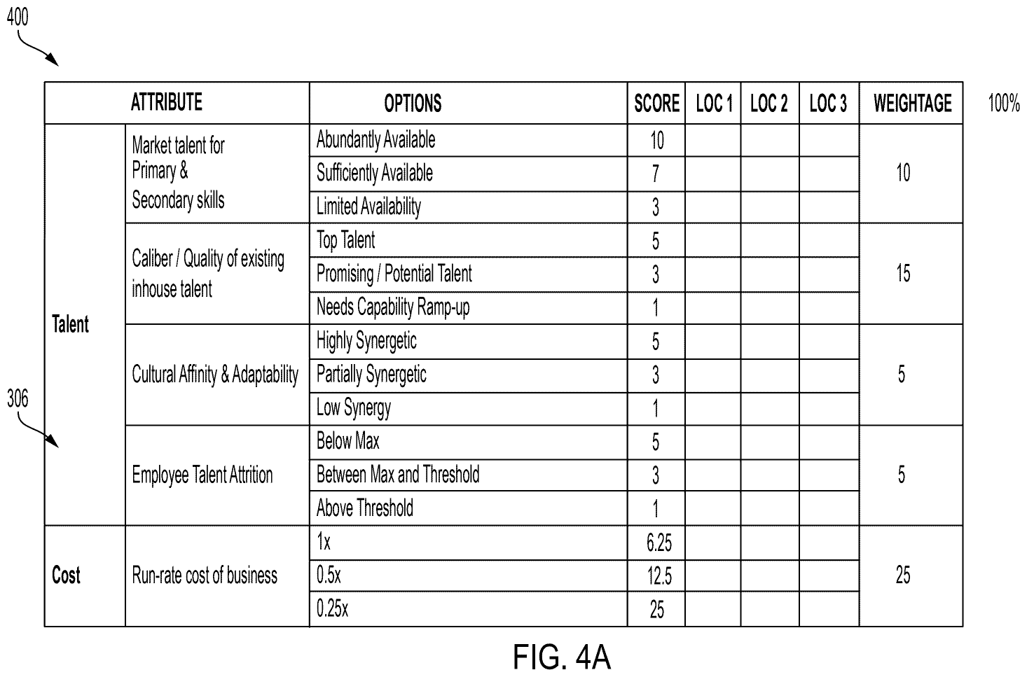

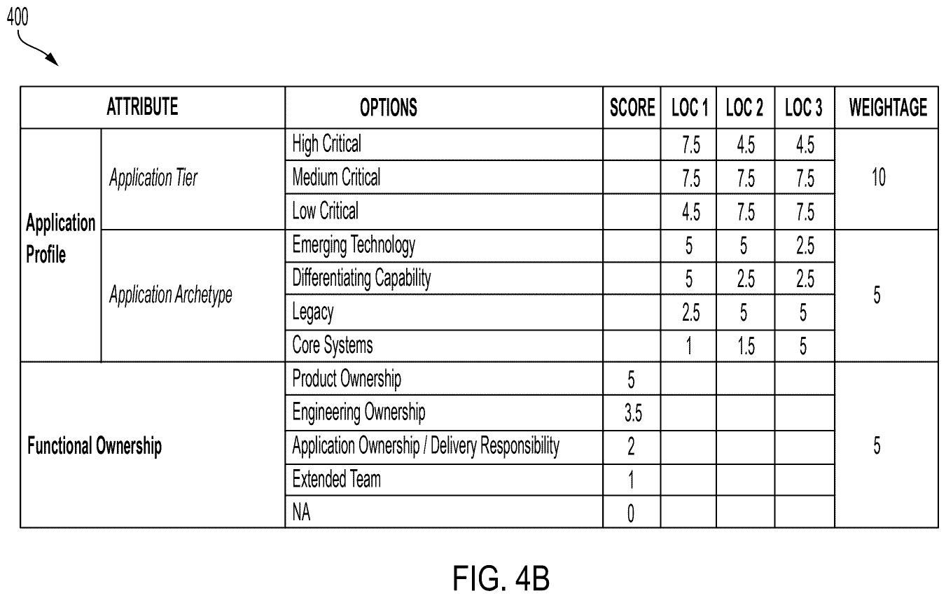

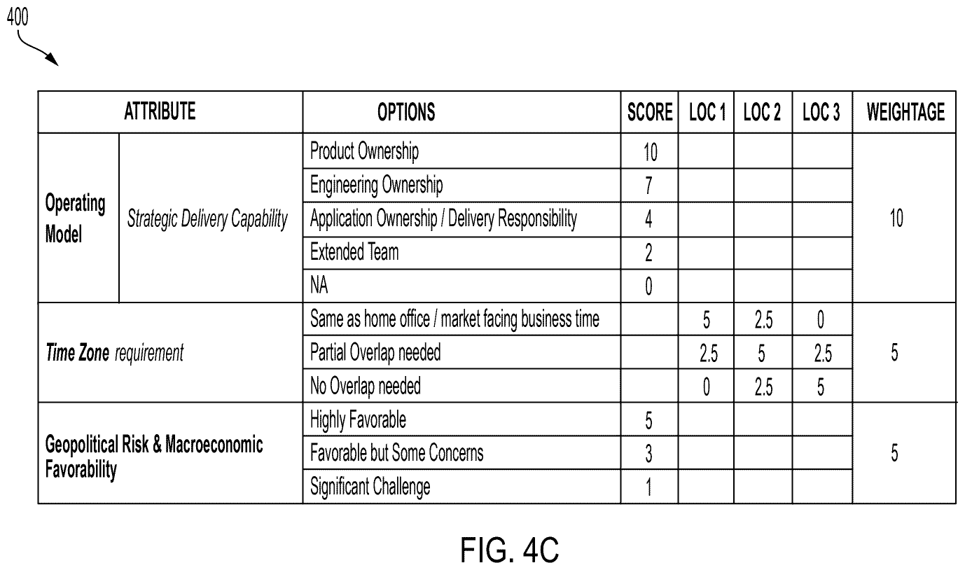

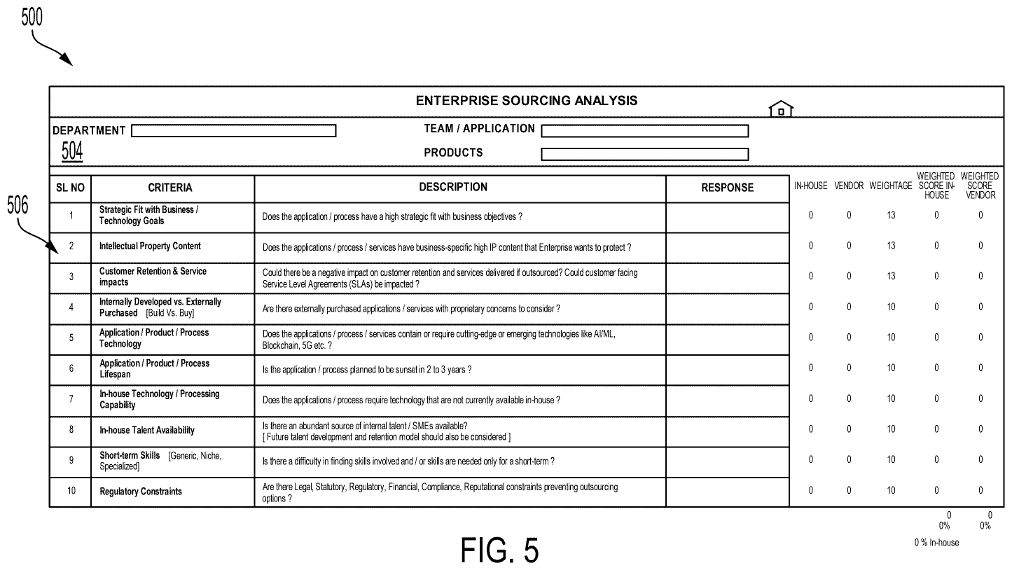

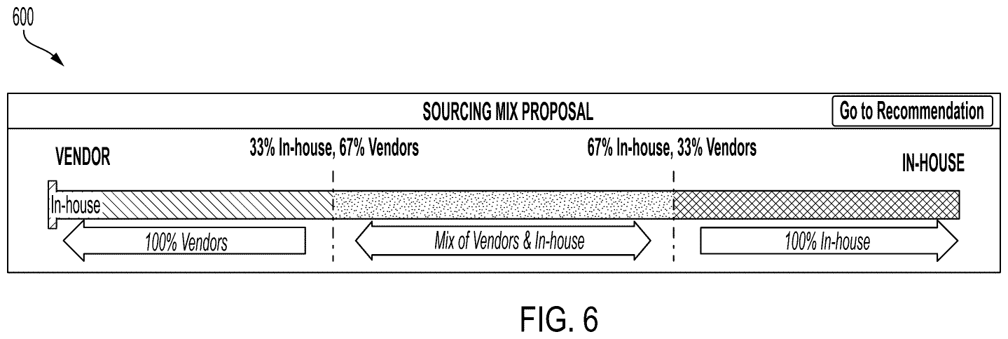

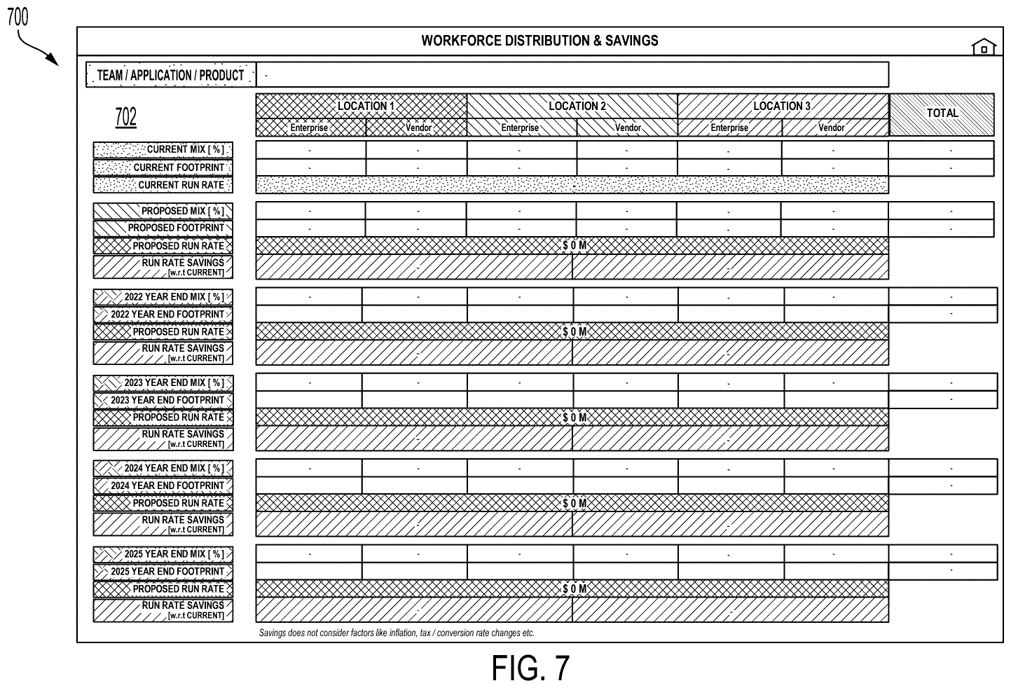

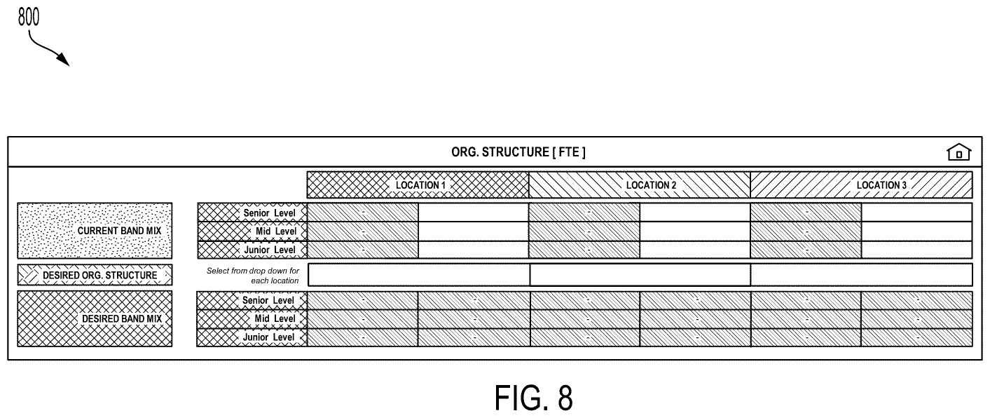

Still referring to FIG. 1, as noted above, the system 100 comprises a display showing various user interfaces 124A on a screen of the computing device 124. For example, the various user interfaces 124A may include, without limitations, a location analysis user interface 300 of FIG. 3, other GUIs 124A for display of items such as a weighted location parameter metrics chart 400 of FIG. 4, a sourcing analysis user interface 500 of FIG. 5, a recommendation module user interface 700 of FIG. 7, and an organizational structure user interface 800 of FIG. 8, and/or other GUIs 124A for providing visual output such as for example, information, graphical reports, messages, or a combination thereof. In an embodiment, the GUI 124A may include a scroll bar 600 as shown in FIG. 6 to display and adapt via the scroll bar 600 a sourcing allocation decision in real-time. The GUI 124A is coupled to the communication path 102 and communicatively coupled to the processor 104. The various user interfaces 124A may be further used to receive input data from a user. The display on the screen of the computing device 124 is coupled to the communication path 102 and communicatively coupled to the processor 104. Accordingly, the communication path 102 communicatively couples the display to other modules of the system 100. The display can comprise any medium capable of transmitting an optical output such as, for example, a cathode ray tube, light emitting diodes, a liquid crystal display, a plasma display, or the like. Additionally, it is noted that the display or the computing device 124 can comprise at least one of the processor 104 and the memory component 106. While the system 100 is illustrated as a single, integrated system in FIG. 1, in other embodiments, the systems can be independent systems.

The system 100 comprises the artificial intelligence module 116 having a first and a second machine-learning function that allows the continuous input and output data of the business recommendation module 112, the location analysis module 112A and the sourcing analysis module 112B in the tuning the respective modules for generating the business planning recommendation for a project based on training data as well as historical data of the project over time and/or other projects. The artificial intelligence module 116 may provide machine learning capabilities to a neural network as described herein. The artificial intelligence module 116 is coupled to the communication path 102 and communicatively coupled to the processor 104.

Data stored and manipulated in the system 100 as described herein is utilized by the artificial intelligence module 116, which is able to leverage a cloud computing-based network configuration such as the cloud to apply Machine Learning and Artificial Intelligence. This machine learning application may create models that can be applied by the intelligent acceptability system 100, to make it more efficient and intelligent in execution. As an example and not a limitation, the artificial intelligence module 116 may include artificial intelligence components selected from the group consisting of an artificial intelligence engine, Bayesian inference engine, and a decision-making engine, and may have an adaptive learning engine further comprising a deep neural network learning engine.

The system 100 comprises the network interface hardware 118 for communicatively coupling the system 100 with a computer network such as network 122. The network interface hardware 118 is coupled to the communication path 102 such that the communication path 102 communicatively couples the network interface hardware 118 to other modules of the system 100. The network interface hardware 118 can be any device capable of transmitting and/or receiving data via a wireless network. Accordingly, the network interface hardware 118 can comprise a communication transceiver for sending and/or receiving data according to any wireless communication standard. For example, the network interface hardware 118 can comprise a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 1, data from various applications running on computing device 124 can be provided from the computing device 124 to the system 100 via the network interface hardware 118. The computing device 124 can be any device having hardware (e.g., chipsets, processors, memory, etc.) for communicatively coupling with the network interface hardware 118 and a network 122. Specifically, the computing device 124 can comprise an input device having an antenna for communicating over one or more of the wireless computer networks described above.

The network 122 can comprise any wired and/or wireless network such as, for example, wide area networks, metropolitan area networks, the internet, an intranet, satellite networks, or the like. Accordingly, the network 122 can be utilized as a wireless access point by the computing device 124 to access one or more servers (e.g., a server 120). The server 120 and any additional servers generally comprise processors, memory, and chipset for delivering resources via the network 122. Resources can include providing, for example, processing, storage, software, and information from the server 120 to the system 100 via the network 122. Additionally, it is noted that the server 120 and any additional servers can share resources with one another over the network 122 such as, for example, via the wired portion of the network, the wireless portion of the network, or combinations thereof.

Still referring to FIG. 1, the system 100 comprises various modules, including the location analysis module 112A, the sourcing analysis module 112B, and the business recommendation module 112 for generating one or more business planning recommendations for a project in accordance with the process 200 of FIG. 2 and as described herein. The various modules are coupled to the communication path 102 and communicatively coupled to the processor 104.

Referring to FIG. 2, an embodiment of a process 200 is shown for the use of various modules described herein and interfaces of FIGS. 3-8 (as implemented by the system 100 of FIG. 1). In block 202, the location analysis module 112A is configured to generate weighted location metrics based on location metrics that are received at the location analysis module 112A. In block 204, the location analysis module 112A generates a location allocation decision based on the weighted location metrics. The location allocation decision includes an allocation of a percentage of the project to house at each location of the at least two locations 302 of an enterprise.

Referring to FIG. 3, a display screen of the location analysis user interface 300 of the location analysis module 112A of the system 100 of FIG. 1 is shown. In embodiments, the location analysis user interface 300 may include various input fields for a user to input various parameters for the location analysis module 112A to analyze and arrive at the location allocation decision. The location analysis user interface 300 includes inputs for one or more locations 302, a number of personnel across internal and external locations 302 such as through a number of personnel input 304, and one or more location parameters 306.

In embodiments, the location metrics may include (i) a number of personnel at each location of at least two locations 302 of the enterprise and (ii) one or more location parameters 306 comprising respective weighted location parameter metrics. The number of personnel may be input via the number of personnel input 304 of the location analysis user interface 300. In embodiments, the number of personnel may be retrieved from a database 114 of the enterprise for display at the number of personnel input 304 fields of the location analysis user interface 300. The one or more location parameters 306 may include, without limitations, available talent of personnel, cost to business to run the project, criticality of the project at a location 302, current and future functional ownership and accountability of personnel at a location 302 with respective the project, a time zone requirement indicative of required overlap with a predetermined prioritized business time zone, and business environment stability of a location 302.

The respective weighted location parameter metrics of the one or more location parameters 306 may aggregate to 100% as shown in the weightage column of FIG. 3 and in the first through third portions of the weighted location parameter metrics chart 400 of FIGS. 4A-4C, described in greater detail further below.

FIG. 5 depicts a display screen of a sourcing analysis user interface 500 of the sourcing analysis module 112B. The source analysis user interface 500 includes a project details user interface 504 to input aspects of the project, such as a department, team or application title or designation, and product (e.g., project) name or designation. The sourcing analysis user interface 500 further includes one or more sourcing input parameters 506, as will be described in greater detail further below.

Referring again to FIG. 2, in block 206, the sourcing analysis module 112B is configured to generate weighted sourcing metrics based on sourcing input parameters 506 received at the sourcing analysis module 112B (e.g., based on input received within a response section of the sourcing analysis user interface 500 of FIG. 5). The weighted sourcing metrics may include one or more sourcing parameters comprising respective weighted sourcing parameter metrics. The one or more sourcing parameters for the project may include, without limitations, strategic fit with enterprise objectives, intellectual property content ranking, customer impacts, third party purchase factors, emerging technologies usage, project sunset time period, enterprise in-house technology capability, enterprise in-house talent availability, skills time period, and regulatory constraints, and other criteria, such as shown with respect to the criteria column of the sourcing analysis user interface 500 of FIG. 5.

In block 208 of FIG. 2, the sourcing analysis module 112B is configured to generate a sourcing allocation decision based on the weighted sourcing metrics. The sourcing allocation decision includes an allocation of a percentage of the project to source internally within the enterprise and externally outside the enterprise.

In block 210, the business recommendation module 112 is configured to generate a business plan recommendation. The business plan recommendation includes a location and sourcing allocation decision for each location 302 based on a combination of the location allocation decision of block 204 and the sourcing allocation decision of block 206.

Referring again to FIG. 3, the location analysis user interface 300 may include input fields for the user to input or select at least two locations 302 from all available locations 302 of the enterprise for the project. The location analysis user interface 300 may further include input fields for the user to input the location metrics. The location metrics may include, via the number of personnel input 304, a number of personnel at each selected location 302 (and outside vendor location) of the enterprise and scores for one or more location parameters 306 at each location 302 of the analysis. For example, the user may input the information of the locations 302, such as the number of personnel of each location 302 and the primary and secondary skills as well as points of contact of each location 302. The location analysis module 112A may retrieve data directly from the database 114 if any parameter is associated with another, such as a location in associated with the number of personnel input 304 and skills. Further, the user may select or input the one or more location parameters 306.

As illustrated in FIG. 3, as described above, the one or more location parameters 306 may include, without limitations, available talent of personnel, cost to business to run the project, criticality of the project at a location 302, current and future functional ownership and accountability of personnel at a location 302 with respective the project, a time zone requirement indicative of required overlap with a predetermined prioritized business time zone, and business environment stability of a location 302. For each location parameter 306, the user may select an option out of one or more candidate options of each location 302 as shown via the weighted location parameter metrics chart 400 of FIGS. 4A-4C. For example, for location parameter “available talent of personnel,” a user may input or select “sufficiently available” option for location 1 and “abundantly available” option for location 2. The location analysis module 112A may generate the weighted location metric for each location 302 based on the selected option associated with the location parameters 306 and respective weighted location parameter metrics (the max weightage score for each location parameter 306) associated with the location parameters 306. For example, the location analysis module 112A may assign respective weighted location parameter metrics of an overall weightage percentage of 10 to the location parameter “available talent of personnel” (shown as “market talent for primary and secondary skills” in FIG. 4A). The location analysis module 112A may determine a weighted location metric of 7 to location 1 based on the selected “sufficiently available” option for location 1. Further, the location analysis module 112B may assign a weighted location metric of 10 to location 2 based on the selected “abundantly available” option for location 2. In embodiments, the respective weighted location parameter metrics (e.g., the respective weightage shown in FIGS. 4A-4C) of the one or more location parameters 306 may aggregate to 100%.

The location analysis module 112A may include a location analysis model to generate a location allocation decision based on the weighted location metrics. The location allocation decision may include an allocation of a percentage of the project to house at each location 302 of the enterprise. The location analysis module 112A may have the first machine learning function included in the artificial intelligence module 116 that allows continuous input (such as the locations 302, the number of personnel input 304, and the location parameters 306) and output data (such as the location allocation decision) to tune the location analysis model.

In some embodiments, the location analysis user interface 300 of the location analysis module 112A may include input fields for the information of the project. For example, as illustrated in FIG. 3, the input fields may include department, team/application, and products (e.g., as the project). The information of the project may be used by the user or the system 100 as additional factors in generating the location allocation decision.

Referring to FIGS. 4A-4C, a display screen of the weighted location parameter metrics chart 400 of the location analysis module 112A is shown. The display screen includes the list of the location parameters 306, options that may be selected by the user in the location analysis user interface 300 of the location analysis module 112A for each location parameter 306, a weightage score associated with each option, and respective weighted location parameter metrics that indicates a max weightage score for each location parameter 306. For example, for the location parameter of “talent” and sub-location parameter of “market talent for primary and secondary skills,” three options are available for the user to select under the associated available talent of personnel as market talent for primary and secondary skills for each location 302. The three options are “abundantly available,” “sufficiently available”, and “limited available.” The max weightage score percentage for the sub-location parameter “market talent for primary and secondary skills” is 10%. The weightage scores for the three options “abundantly available,” “sufficiently available”, and “limited available” are 10, 7, and 3, respectively. In embodiments, the respective weighted location parameter metrics of the location parameters 306 may aggregate to 100%.

Referring to FIG. 5, a display screen of the sourcing analysis user interface 500 of the sourcing analysis module 112B is shown. The sourcing analysis user interface 500 may include a project details input interface 504. The project details input interface 504 may include input fields for a user to input one or more sourcing input parameters 506. The sourcing analysis module 112B may generate weighted sourcing metrics based on sourcing input parameters 506. The sourcing metric may include one or more sourcing parameters. The one or more sourcing parameters may include respective weighted sourcing parameter metrics. In embodiments, as described above, the one or more sourcing parameters for the project may include, without limitations, strategic fit with enterprise objectives, intellectual property content ranking, customer impacts, third party purchase factors, emerging technologies usage, project sunset time period, enterprise in-house technology capability, enterprise in-house talent availability, skills time period, and regulatory constraints. The user may select or input a sourcing input parameter 506 associated with each sourcing parameter. For example, as illustrated in FIG. 5, for the sourcing input parameter “strategic fit with enterprise objectives,” the user may select the option “No” as a response for the sourcing input parameter 506 to a posed question of “Does the application/process have a high strategic fit with the business objectives?” The overall weightage for this sourcing input parameter 506 may be 13% as shown in FIG. 5. In embodiments, the respective weighted sourcing parameter metrics may aggregate to 100%. Based on the responses, the sourcing analysis user interface 500 may determine display weighted scores between in-house (e.g., internal enterprise) and vendor (e.g., external) allocations to equal the respective overall weightage scores for each sourcing input parameter 506 and display an associated number of how many personnel to are allocated at the in-house and vendor locations.

In embodiments, based on the sourcing input parameters 506 associated with each sourcing parameters, the sourcing analysis module 112B may generate weighted sourcing metrics for the enterprise and the one or more vendors. The sourcing analysis module 112B may include a weighted sourcing parameter metrics chart. The weighted sourcing parameter metrics chart may include options for each sourcing parameter of the sourcing analysis module 112B, respective weighted sourcing parameter metrics for each sourcing parameter, and the weighted sourcing metrics of the enterprise and the vendors. For example, as described above and as illustrated in

FIG. 5, the sourcing input parameter 506 of “strategic fit with enterprise objectives” may include two options “Yes” and “No” for the user to select as the sourcing input parameter 506. In embodiments, this information may be stored with retrieved from the database 114 of the enterprise. The respective weighted sourcing parameter metric for the input sourcing parameter “strategic fit with enterprise objectives” is 13%. The weighted sourcing metric for the option “Yes” may be 13% for house and 0% for vendor. The weighted sourcing metric for the option “No” may be 0% for house and 13% for vendor.

The sourcing analysis module 112B may include a sourcing analysis model to generate a sourcing allocation decision based on the weighted sourcing metrics. The sourcing allocation decision includes an allocation of a percentage of the project to source internally within the enterprise and externally outside the enterprise. The sourcing analysis module 112B may have the second machine learning function included in the artificial intelligence module 116 that allows the continuous input (such as the sourcing input parameters 506) and output data (such as the sourcing allocation decision) to tune the sourcing analysis model.

Referring to FIG. 6, a display screen of the scroll bar 600 of a GUI 124A is shown. The GUI 124A may be communicatively coupled to the processor, and the scroll bar 600 may be configured for display and adaptable scrolling across the scroll bar 600 by a user on the GUI 124A. For example, the scroll bar 600 may indicate 25% of the project is recommended to be performed by the internal personnel of the enterprise (i.e., in-house) and 75% of the project is recommended to be performed by external contractors (i.e., vendors). In embodiments, the scroll bar 600 may be configured to be updated in real-time to reflect any sourcing allocation adjustments made to any of the sourcing input parameters 506.

Referring to FIG. 7, a display screen of a recommendation module user interface 700 of the business recommendation module 112 is shown. The display screen of the recommendation module user interface 700 includes a cost scenarios interface 702. The recommendation user interface 700 may include a location and sourcing allocation decision, which includes the information of the allocation of the internal and external sources and personnel to each location 302.

The business recommendation module 112 generates one or more business plan recommendations and display on the cost scenarios interface 702. The one or more business plan recommendations include a location and sourcing allocation decision for each location 302 based on a combination of the location allocation decision and the sourcing allocation decision. In some embodiments, the location and sourcing allocation decision may include an updated location allocation decision and an updated sourcing allocation decision. The updated location allocation decision may include the allocation of a percentage of the project to house at each location 302 based on the sourcing allocation decision. The updated sourcing allocation decision may include an allocation of a percentage of the project to source internally within each location 302 and externally outside the enterprise based on the location allocation decision. In embodiments, the location and sourcing allocation decision for each location 302 may include a headcount mix of a number of allocated internal personnel and external contractors for each location 302. The business plan recommendation may include updated cost savings associated with adjustments in the location allocation decision and the sourcing allocation decision for distribution of personnel members across each location 302 and allocation between internal and external personnel at each location 302 for the project.

In embodiments, the business plan recommendation may be configured to be updated in real-time to generate one or more simulations, cost scenarios, or combinations thereof based on changes to (i) the weighted location metrics and (ii) the weighted sourcing metrics of the enterprise and the vendors. The business recommendation module 112 may generate cost savings configured to be separated into a yearly breakdown analysis for a specific period of years (such as 1, 3, 5 years).

Referring to FIG. 8 a display screen of an organizational structure user interface 800 at each location 302 of the enterprise of the system 100 of FIG. 1 is shown. The organizational structure user interface 800 of the business recommendation module 112 may allow the user to fine-tune the personnel structure at each location 302 by selecting a personnel structure. For example, a house at each location 302 may have workforces across Senior, Mid, and Junior levels, and the personnel structure may be diamond or pyramid. The diamond personnel structure may include a limited number of Senior-level employees overseeing a smaller group of Mid-level employees who, in turn, manage a larger number of Junior-level employees. The pyramid personnel structure may be characterized by a broader base of Junior-level employees, a middle layer of Mid-level employees, and a narrower apex of Senior-level employees. Upon the user selection of a personnel structure, the business recommendation module 112 may generate a recommendation of a number of personnel for each location 302 based on the selected personnel structure. The user may compare the recommendation with the current number of personnel for each location 302 and conduct any adjustments as updates.

In embodiments, the systems and methods as described herein assist in significantly enhancing efficiencies of automatic and intelligent decision-making for business planning of a project. As a non-limiting example, such a plurality of location data, location metrics, and sourcing parameters may be received from the location analysis module and the sourcing analysis module and used in combination to generate an overall business recommendation among at least two different locations 302 of the enterprise. The systems and methods provide a more efficient processing system to organize and analyze the plurality of input data to determine the human capital planning, location and sourcing strategies, and organization and cost structures that are tailored to the specific needs of the enterprise at a speedier rate, which assists to reduce an amount of time spent by a machine or person analyzing the plurality of input data. Further, machine learning techniques based on the continuous input and output data may be utilized to generate a more accurate business planning recommendation for a project in light of the plurality of the input parameters, such as the location metrics and the scoring input parameters.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” or “programmed” in a particular way, to embody a particular property, or to function in a particular manner, are structural recitations, as opposed to recitations of intended use.

It is noted that terms like “preferably,” “commonly,” and “typically,” when utilized herein, are not utilized to limit the scope of the claimed disclosure or to imply that certain features are critical, essential, or even important to the structure or function of the claimed disclosure. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

### Aspects Listing:

Aspect 1. A system for generating a business planning recommendation for a project, the system comprising: a processor; a memory; a location analysis module; a sourcing analysis module; a business recommendation module, wherein the memory, the location analysis module, the sourcing analysis module, and the business recommendation module are communicatively coupled to the processor; and one or more machine-readable instructions stored in the memory that cause the system to perform at least the following when executed by the processor: generating, by the location analysis module, weighted location metrics based on location metrics received at the location analysis module; generating, by the location analysis module, a location allocation decision based on the weighted location metrics, the location allocation decision comprising an allocation of a percentage of the project to house at each location of at least two locations of an enterprise; generating, by the sourcing analysis module, weighted sourcing metrics based on sourcing input parameters received at the sourcing analysis module; generating, by the sourcing analysis module, a sourcing allocation decision based on the weighted sourcing metrics, the sourcing allocation decision comprising an allocation of a percentage of the project to source internally within the enterprise and externally outside the enterprise; generating, by the business recommendation module, a business plan recommendation comprising a location and sourcing allocation decision for each location based on a combination of the location allocation decision and the sourcing allocation decision.

Aspect 2. The system of Aspect 1, wherein the location metrics comprise (i) a number of personnel at each location of the at least two locations of the enterprise and (ii) one or more location parameters comprising respective weighted location parameter metrics.

Aspect 3. The system of Aspect 2, wherein the one or more location parameters comprise available talent of personnel, cost to business to run the project, criticality of the project at a location, current and future functional ownership and accountability of personnel at a location with respective the project, a time zone requirement indicative of required overlap with a predetermined prioritized business time zone, and business environment stability of a location.

Aspect 4. The system of Aspect 2 or Aspect 3, wherein the respective weighted location parameter metrics of the one or more location parameters aggregate to 100%.

Aspect 5. The system of any of Aspect 1 to Aspect 4, wherein the sourcing metrics comprise one or more sourcing parameters comprising respective weighted sourcing parameter metrics.

Aspect 6. The system of Aspect 5, wherein the one or more sourcing parameters for the project comprise strategic fit with enterprise objectives, intellectual property content ranking, customer impacts, third party purchase factors, emerging technologies usage, project sunset time period, enterprise in-house technology capability, enterprise in-house talent availability, skills time period, and regulatory constraints.

Aspect 7. The system of any of Aspect 1 to Aspect 6, the system further comprising a graphical user interface (GUI) communicatively coupled to the processor, and a scroll bar configured for display on the GUI, the scroll bar on a configured to be updated in real-time to reflect any sourcing allocation adjustments of the business plan recommendation made based on adjusted made to any of the sourcing input parameters.

Aspect 8. The system of any of Aspect 1 to Aspect 7, wherein the location and sourcing allocation decision comprises (i) an updated location allocation decision comprising allocation of a percentage of the project to house at each location of the at least two locations of the enterprise based on the sourcing allocation decision and (ii) an updated sourcing allocation decision comprising an allocation of a percentage of the project to source internally within each location of the at least two locations of the enterprise and externally outside the enterprise based on the location allocation decision.

Aspect 9. The system of any of Aspect 1 to Aspect 8, wherein the business plan recommendation is configured to be updated in real-time to generate one or more simulations, cost scenarios, or combinations thereof based on changes to (i) the weighted location metrics and (ii) the weighted sourcing metrics.

Aspect 10. The system of any of Aspect 1 to Aspect 9, wherein the location and sourcing allocation decision for each location comprises a headcount mix of a number of allocated internal personnel and external contractors for each location.

Aspect 11. The system of any of Aspect 1 to Aspect 10, wherein the business plan recommendation comprises updated cost savings for display associated with adjustments in the location and sourcing allocation decision for distribution of personnel members across each location and allocation between internal and external personnel at each location for the project.

Aspect 12. The system of any of Aspect 11, wherein the updated cost savings are configured to be separated into a yearly breakdown analysis for a specific period of years.

Aspect 13. A system for generating a business planning recommendation for a project, the system comprising: a processor; a memory; a location analysis module; a sourcing analysis module; a business recommendation module, wherein the memory, the location analysis module, the sourcing analysis module, and the business recommendation module are communicatively coupled to the processor; and one or more machine-readable instructions stored in the memory that cause the system to perform at least the following when executed by the processor: generating, by the location analysis module, weighted location metrics based on location metrics received at the location analysis module, wherein the location metrics comprises one or more location parameters comprising respective weighted location parameter metrics; generating, by the location analysis module, a location allocation decision based on the weighted location metrics, the location allocation decision comprising an allocation of a percentage of the project to house at each location of at least two locations of an enterprise; generating, by the sourcing analysis module, weighted sourcing metrics based on sourcing input parameters received at the sourcing analysis module, wherein the sourcing metrics comprise one or more sourcing parameters comprising respective weighted sourcing parameter metrics; generating, by the sourcing analysis module, a sourcing allocation decision based on the weighted sourcing metrics, the sourcing allocation decision comprising an allocation of a percentage of the project to source internally within the enterprise and externally outside the enterprise; generating, by the business recommendation module, a business plan recommendation comprising a location and sourcing allocation decision for each location based on a combination of the location allocation decision and the sourcing allocation decision.

Aspect 14. The system of Aspect 13, wherein the location metrics further comprise a number of personnel at each location of the at least two locations of the enterprise.

Aspect 15. The system of Aspect 13 or Aspect 14, wherein the one or more location parameters comprise available talent of personnel, cost to business to run the project, criticality of the project at a location, current and future functional ownership and accountability of personnel at a location with respective the project, a time zone requirement indicative of required overlap with a predetermined prioritized business time zone, and business environment stability of a location.

Aspect 16. The system of any of Aspect 13 to Aspect 15, the system further comprising a graphical user interface (GUI) communicatively coupled to the processor, and a scroll bar configured for display on the GUI, the scroll bar on a configured to be updated in real-time to reflect any sourcing allocation adjustments of the business plan recommendation made based on adjusted made to any of the sourcing input parameters.

Aspect 17. The system of any of Aspect 13 to Aspect 16, wherein the location and sourcing allocation decision comprises (i) an updated location allocation decision comprising allocation of a percentage of the project to house at each location of the at least two locations of the enterprise based on the sourcing allocation decision and (ii) an updated sourcing allocation decision comprising an allocation of a percentage of the project to source internally within each location of the at least two locations of the enterprise and externally outside the enterprise based on the location allocation decision.

Aspect 18. The system of any of Aspect 13 to Aspect 17, wherein the business plan recommendation is configured to be updated in real-time to generate one or more simulations, cost scenarios, or combinations thereof based on changes to (i) the weighted location metrics and (ii) the weighted sourcing metrics.

Aspect 19. A method for generating a business planning recommendation for a project, the method comprising: generating, by a location analysis module, weighted location metrics based on location metrics received at the location analysis module; generating, by the location analysis module, a location allocation decision based on the weighted location metrics, the location allocation decision comprising an allocation of a percentage of the project to house at each location of at least two locations of an enterprise; generating, by a sourcing analysis module, weighted sourcing metrics based on sourcing input parameters received at the sourcing analysis module; generating, by the sourcing analysis module, a sourcing allocation decision based on the weighted sourcing metrics, the sourcing allocation decision comprising an allocation of a percentage of the project to source internally within the enterprise and externally outside the enterprise; generating, by a business recommendation module, a business plan recommendation comprising a location and sourcing allocation decision for each location based on a combination of the location allocation decision and the sourcing allocation decision.

Aspect 20. The method of Aspect 19, wherein the method further comprises displaying a scroll bar configured for display on a graphical user interface (GUI), the scroll bar on a configured to be updated in real-time to reflect any sourcing allocation adjustments of the business plan recommendation made based on adjusted made to any of the sourcing input parameters.

What is claimed is:

1. A system for generating a business planning recommendation for a project, the system comprising:
a processor;
a memory;
a location analysis module;
a sourcing analysis module;
a business recommendation module, wherein the memory, the location analysis module, the sourcing analysis module, and the business recommendation module are communicatively coupled to the processor; and
one or more machine-readable instructions stored in the memory that cause the system to perform at least the following when executed by the processor:
generating, by the location analysis module, weighted location metrics based on location metrics received at the location analysis module;
generating, by the location analysis module, a location allocation decision based on the weighted location metrics, the location allocation decision comprising an allocation of a percentage of the project to house at each location of at least two locations of an enterprise;
generating, by the sourcing analysis module, weighted sourcing metrics based on sourcing input parameters received at the sourcing analysis module;
generating, by the sourcing analysis module, a sourcing allocation decision based on the weighted sourcing metrics, the sourcing allocation decision comprising an allocation of a percentage of the project to source internally within the enterprise and externally outside the enterprise; and
generating, by the business recommendation module, a business plan recommendation comprising a location and sourcing allocation decision for each location based on a combination of the location allocation decision and the sourcing allocation decision.

2. The system of claim 1, wherein the location metrics comprise (i) a number of personnel at each location of the at least two locations of the enterprise and (ii) one or more location parameters comprising respective weighted location parameter metrics.

3. The system of claim 2, wherein the one or more location parameters comprise available talent of personnel, cost to business to run the project, criticality of the project at a location, current and future functional ownership and accountability of personnel at a location with respective the project, a time zone requirement indicative of required overlap with a predetermined prioritized business time zone, and business environment stability of a location.

4. The system of claim 2, wherein the respective weighted location parameter metrics of the one or more location parameters aggregate to 100%.

5. The system of claim 1, wherein the sourcing metrics comprise one or more sourcing parameters comprising respective weighted sourcing parameter metrics.

6. The system of claim 5, wherein the one or more sourcing parameters for the project comprise strategic fit with enterprise objectives, intellectual property content ranking, customer impacts, third party purchase factors, emerging technologies usage, project sunset time period, enterprise in-house technology capability, enterprise in-house talent availability, skills time period, and regulatory constraints.

7. The system of claim 1, the system further comprising a graphical user interface (GUI) communicatively coupled to the processor, and a scroll bar configured for display on the GUI, the scroll bar on a configured to be updated in real-time to reflect any sourcing allocation adjustments of the business plan recommendation made based on adjusted made to any of the sourcing input parameters.

8. The system of claim 1, wherein the location and sourcing allocation decision comprises (i) an updated location allocation decision comprising allocation of a percentage of the project to house at each location of the at least two locations of the enterprise based on the sourcing allocation decision and (ii) an updated sourcing allocation decision comprising an allocation of a percentage of the project to source internally within each location of the at least two locations of the enterprise and externally outside the enterprise based on the location allocation decision.

9. The system of claim 1, wherein the business plan recommendation is configured to be updated in real-time to generate one or more simulations, cost scenarios, or combinations thereof based on changes to (i) the weighted location metrics and (ii) the weighted sourcing metrics.

10. The system of claim 1, wherein the location and sourcing allocation decision for each location comprises a headcount mix of a number of allocated internal personnel and external contractors for each location.

11. The system of claim 1, wherein the business plan recommendation comprises updated cost savings for display associated with adjustments in the location and sourcing allocation decision for distribution of personnel members across each location and allocation between internal and external personnel at each location for the project.

12. The system of claim 11, wherein the updated cost savings are configured to be separated into a yearly breakdown analysis for a specific period of years.

13. A system for generating a business planning recommendation for a project, the system comprising:
a processor;
a memory;
a location analysis module;
a sourcing analysis module;
a business recommendation module, wherein the memory, the location analysis module, the sourcing analysis module, and the business recommendation module are communicatively coupled to the processor; and
one or more machine-readable instructions stored in the memory that cause the system to perform at least the following when executed by the processor:
generating, by the location analysis module, weighted location metrics based on location metrics received at the location analysis module, wherein the location metrics comprises one or more location parameters comprising respective weighted location parameter metrics;
generating, by the location analysis module, a location allocation decision based on the weighted location metrics, the location allocation decision comprising an allocation of a percentage of the project to house at each location of at least two locations of an enterprise;
generating, by the sourcing analysis module, weighted sourcing metrics based on sourcing input parameters received at the sourcing analysis module, wherein the sourcing metrics comprise one or more sourcing parameters comprising respective weighted sourcing parameter metrics;
generating, by the sourcing analysis module, a sourcing allocation decision based on the weighted sourcing metrics, the sourcing allocation decision comprising an allocation of a percentage of the project to source internally within the enterprise and externally outside the enterprise; and
generating, by the business recommendation module, a business plan recommendation comprising a location and sourcing allocation decision for each location based on a combination of the location allocation decision and the sourcing allocation decision.

14. The system of claim 13, wherein the location metrics further comprise a number of personnel at each location of the at least two locations of the enterprise.

15. The system of claim 13, wherein the one or more location parameters comprise available talent of personnel, cost to business to run the project, criticality of the project at a location, current and future functional ownership and accountability of personnel at a location with respective the project, a time zone requirement indicative of required overlap with a predetermined prioritized business time zone, and business environment stability of a location.

16. The system of claim 13, the system further comprising a graphical user interface (GUI) communicatively coupled to the processor, and a scroll bar configured for display on the GUI, the scroll bar on a configured to be updated in real-time to reflect any sourcing allocation adjustments of the business plan recommendation made based on adjusted made to any of the sourcing input parameters.

17. The system of claim 13, wherein the location and sourcing allocation decision comprises (i) an updated location allocation decision comprising allocation of a percentage of the project to house at each location of the at least two locations of the enterprise based on the sourcing allocation decision and (ii) an updated sourcing allocation decision comprising an allocation of a percentage of the project to source internally within each location of the at least two locations of the enterprise and externally outside the enterprise based on the location allocation decision.

18. The system of claim 13, wherein the business plan recommendation is configured to be updated in real-time to generate one or more simulations, cost scenarios, or combinations thereof based on changes to (i) the weighted location metrics and (ii) the weighted sourcing metrics.

19. A method for generating a business planning recommendation for a project, the method comprising:
generating, by a location analysis module, weighted location metrics based on location metrics received at the location analysis module;
generating, by the location analysis module, a location allocation decision based on the weighted location metrics, the location allocation decision comprising an allocation of a percentage of the project to house at each location of at least two locations of an enterprise;
generating, by a sourcing analysis module, weighted sourcing metrics based on sourcing input parameters received at the sourcing analysis module;
generating, by the sourcing analysis module, a sourcing allocation decision based on the weighted sourcing metrics, the sourcing allocation decision comprising an allocation of a percentage of the project to source internally within the enterprise and externally outside the enterprise; and
generating, by a business recommendation module, a business plan recommendation comprising a location and sourcing allocation decision for each location based on a combination of the location allocation decision and the sourcing allocation decision.

20. The method of claim 19, wherein the method further comprises displaying a scroll bar configured for display on a graphical user interface (GUI), the scroll bar on a configured to be updated in real-time to reflect any sourcing allocation adjustments of the business plan recommendation made based on adjusted made to any of the sourcing input parameters.
